(19) United States
(12) Patent Application Publication
(10) Pub. No.: US 2019/0019246 A1
(43) Pub. Date: Jan. 17, 2019

(54) SYSTEMS AND METHODS FOR ASSESSING FINANCIAL STABILITY AND PREPAREDNESS

(71) Applicant: HelloWallet, LLC, Washington, DC (US)

(72) Inventors: Richard Bowman, Washington, DC (US); Stephen Wendel, Hyattsville, MD (US); Michael Yoch, Washington, DC (US)

(21) Appl. No.: 15/855,979

(22) Filed: Dec. 27, 2017

Related U.S. Application Data
(63) Continuation of application No. 13/757,350, filed on Feb. 1, 2013, now abandoned.

(51) Int. Cl. G06Q 40/00

(52) U.S. Cl. CPC G06Q 40/00

(57) ABSTRACT

To facilitate assessment of financial stability and preparedness. In an embodiment, a financial advice system associates a first maximum sub-component value and a first actual value, based on first data related to financial conditions of a first user, with a first sub-component. The financial advice system associates a second maximum sub-component value and a second actual value, based on second data related to the financial conditions of the first user, with a second sub-component. The financial advice system determines a first user score associated with financial stability of the first user based on the first maximum sub-component value and the first actual value associated with the first sub-component and the second maximum sub-component value and the second actual value associated with the second sub-component.

### CROSS-REFERENCE TO RELATED APPLICATIONS

This application is a continuation of U.S. patent application Ser. No. 13/757,350, filed on Feb. 1, 2013 and entitled “SYSTEMS AND METHODS FOR ADDRESSING FINANCIAL STABILITY AND PREPAREDNESS”, which is incorporated herein by reference in its entirety.

### FIELD OF THE INVENTION

The present invention relates to the field of financial management. More particularly, the present invention provides a technique for assessing financial stability and preparedness.

### BACKGROUND

Financial planning has been an important consideration practically since the advent of money. Any individual who earns and saves money may have a need to take stock of his finances and plan for the future. The desire to maximize wealth may cause individuals to seek strategies for stretching their money as far as they can, creating opportunities for those who are able to formulate such strategies. This has led to the emergence of a plethora of products and services aimed at helping individuals understand their finances and develop strategies for spending, saving, and investing.

However, many individuals may find it difficult to assess the state of their finances. The proliferation of financial planning programs, seminars, and websites has led to an abundance of conflicting information. Moreover, many financial planning professionals may provide self-serving advice intended to promote their own services. As a result, many individuals may perceive financial planning as an intimidating, overwhelming task.

The effectiveness of benefits offered by employers may be hampered by these and other difficulties. For example, employers and employees may face challenges in optimizing benefits toward financial planning. Because of uncertainty or inexperience in financial planning, employees may not utilize the benefits provided by their employers properly. Employers may, in turn, find it difficult to tailor their benefits offerings to their employees' needs.

### SUMMARY OF THE INVENTION

To facilitate assessment of financial stability and preparedness, a financial advice system associates a first maximum sub-component value and a first actual value, based on first data related to financial conditions of a first user, with a first sub-component. The financial advice system associates a second maximum sub-component value and a second actual value, based on second data related to the financial conditions of the first user, with a second sub-component. The financial advice system determines a first user score associated with financial stability of the first user based on the first maximum sub-component value and the first actual value associated with the first sub-component and the second maximum sub-component value and the second actual value associated with the second sub-component.

According to an embodiment, the financial advice system associates the first maximum sub-component value and a third actual value, based on third data related to financial conditions of a second user, with the first sub-component. The financial advice system may associate the second maximum sub-component value and a fourth actual value, based on fourth data related to financial conditions of the second user, with the second sub-component. The financial advice system may determine a second user score associated with financial stability of the second user based on the first maximum sub-component value and the third actual value associated with the first sub-component and the second maximum sub-component value and the fourth actual value associated with the second sub-component.

According to an embodiment, the financial advice system determines the first maximum score component value based on a first sub-component weight and determines the second maximum score component value based on second sub-component weight. The financial advice system may select a first sub-component weight to adjust a contribution of the first sub-component on the first user score and select a second sub-component weight to adjust a contribution of the second sub-component on the first user score.

According to an embodiment, a score component includes the first sub-component and the second sub-component. The score component may relate to at least one of categorization of expenses, spending habits, emergency savings, retirement savings, medical savings, automated transfers, home equity, credit card debt, other debts, goals, budgeting, credit awareness, insurance, and recreation. The financial advice system may associate a maximum score component value with the score component based on a score component weight. The financial advice system may determine the first maximum sub-component value based on the maximum score component value and a first sub-component weight. The financial advice system may determine the second maximum sub-component value based on the maximum score component value and a second sub-component weight. In an embodiment, a first score component includes the first sub-component and a second score component includes the second sub-component.

According to an embodiment, the financial advice system determines the first actual value based on at least one of a target and a penalty threshold. The financial advice system may determine the target based on a control parameter. The financial advice system may determine the penalty threshold based on a control parameter.

According to an embodiment, the financial advice system determines the first actual value based on a percentage of the first maximum sub-component value. The financial advice system may determine an actual sum based on a sum of the first actual value and the second actual value. The financial advice system may determine a maximum sum based on a sum of the first maximum sub-component value and the second maximum sub-component value. In an embodiment, the first user score is based on a percentage determined as a quotient of the actual sum and the maximum sum.

According to an embodiment, the first data comprises at least one of financial data received from a financial data provider, organization data received from an organization, and data received from the first user. The first sub-component may relate to at least one of categorization of expenses, spending habits, emergency savings, retirement savings, medical savings, automated transfers, home equity, credit card debt, other debts, goals, budgeting, credit awareness, insurance, and recreation.

According to an embodiment, the financial advice system generates aggregated data based on the first user score and a second user score, anonymizes the aggregated data, and provides the aggregated data to an organization.

Many other features and embodiments of the invention will be apparent from the accompanying drawings and from the following detailed description.

### BRIEF DESCRIPTION OF THE DRAWINGS

FIG. 1 illustrates an environment within which some embodiments of the invention may operate.

FIG. 2 illustrates an example financial advice system in accordance with an embodiment of the invention,

FIG. 3 illustrates an example score calculation module in accordance with an embodiment of the invention.

FIG. 4 illustrates an example data aggregation module in accordance with an embodiment of the invention.

FIG. 5A illustrates an ‘Expenses’ classification of an index and associated score components in accordance with an embodiment of the invention.

FIG. 5B illustrates an ‘Assets’ classification of an index and associated score components in accordance with an embodiment of the invention.

FIG. 5C illustrates a ‘Debts’ classification of an index and associated score components in accordance with an embodiment of the invention.

FIG. 5D illustrates a ‘Diligence’ classification of an index and associated score components in accordance with an embodiment of the invention.

FIG. 5E illustrates a ‘Miscellaneous’ classification of an index and associated score components in accordance with an embodiment of the invention.

FIG. 6 illustrates a process for determining a score based on a user's financial information in accordance with an embodiment of the invention.

FIG. 7 illustrates a process for aggregating score information to provide to an organization in accordance with an embodiment of the invention.

FIG. 8 illustrates an example machine within which a set of instructions for causing the machine to perform one or more of the embodiments described herein can be executed.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

For many individuals, financial planning may be an essential task in preparing for the future. An individual may set financial goals related to retirement, paying for education, emergency savings, or other purposes that involve steadily building wealth. Financial planning may involve evaluating an individual's assets, income, debts, and expenses and formulating a plan for achieving the individual's goals. The plan may include identifying sound investment strategies, budgeting, and paying off debt.

Many services and tools are available to assist people with financial planning. An individual may hire a professional financial planner to keep track of his finances and provide evaluations, guidance, or advice when necessary. Computer applications are available that prompt users for information about their goals and finances and develop a financial profile based on the users' answers. These applications may utilize surveys that ask users to assess themselves. Accountants, tax preparers, and banks may supplement their services by offering financial planning advice and recommendations.

Organizations often provide their members with benefits that may facilitate financial planning and decision-making of the members. For example, many employers provide their employees with retirement savings accounts in which they may deposit a portion of their paycheck before taxes are assessed. The retirement savings account, for example, may allow an employee to earn interest on deposited money or to purchase equities or other financial instruments with growth potential. In some circumstances, the employee may be restricted from withdrawing money from the retirement savings account before he has reached a minimum age. Thus, deposits into a retirement saving account should reflect both retirement and non-retirement financial circumstances and goals.

Many currently available financial planning techniques entail significant drawbacks. Professionals and computer applications are dependent upon information provided to them by their clients or users. Individuals may not have an accurate idea of their own finances, and may provide information that is incorrect, incomplete, or misleading. User-provided information may also be subjective, particularly if it is gathered from surveys that ask the users to assess their own situation and, for example, assign themselves grades. Some techniques may also be unable to track users' finances in real-time. The status of a user's finances may change continuously as the user incurs expenses, pays down debt, acquires assets, or performs other actions that affect the user's financial or personal situation. Currently available techniques may require users to provide updated financial information at designated intervals. Currently available techniques may also base assessments exclusively on certain types of information to the exclusion of other types of relevant information. Evaluations or recommendations provided on the basis of inaccurate, incomplete, subjective, or outdated information may therefore be flawed.

Like individuals, organizations also desire to understand the overall financial health of their members. For example, employers may wish to assess the collective financial health of their employees or subgroups of their employees. An employer may, for example, wish to tailor its benefits offerings to the financial circumstances and needs of its employees. The employer may save money by, for example, identifying and eliminating benefits that may not be useful to employees. Currently, organizations waste vast expenditures on unnecessary or ill-tailored benefits based on misunderstandings about the financial conditions of their members.

Embodiments of the invention provide techniques for creating an index and determining a score to assess a user's financial stability and preparedness based on a holistic, ongoing evaluation of the user's financial situation. Data may be received from financial institutions, employers, and other sources of information related to the users finances. Financial data may be received from financial institutions. The financial data may include transactions, account balances, and other information related to the user's finances. The transactions may be categorized based on their type. For example, a credit card charge at a supermarket may be associated with a ‘grocery’ category. Organization data may be received from an organization, such as an employer. Organization data may include the user's salary, benefits, or other information related to the user's employment. User-provided data may be received from the user. The user-provided data may include information such as the user's age, income, marital status, number of children, or any other information related to the user's financial or personal situation.

A user's financial situation may be represented as score components. The score components may relate to various aspects of a user's financial situation, such as, for example, his credit card debt, his emergency savings, and his retirement savings. A score component may have one or more associated sub-components. The sub-components may relate to more detailed information about aspects of the user's finances such as, for example, the user's total credit card balances and whether the user has paid interest on the balances. Based on the financial data, the organization data, and the user-provided data, responses associated with various score components may be determined for the user.

Based on the responses, values may be determined for the user for each sub-component. The maximum value that a user may receive for a score component may be based on a weight, as described in further detail below. A score may be calculated for the user based on the values determined for the user. The same score components, sub-components, and maximum values may be used for all users. Scores for all users may be standardized such that the user's score may be compared with the scores of other users. In an embodiment, recommendations may be provided to the user based on his score. In an embodiment, multiple users' scores may be aggregated based on criteria specified by an organization, and benefits recommendations may be provided to the organization based on the aggregated scores.

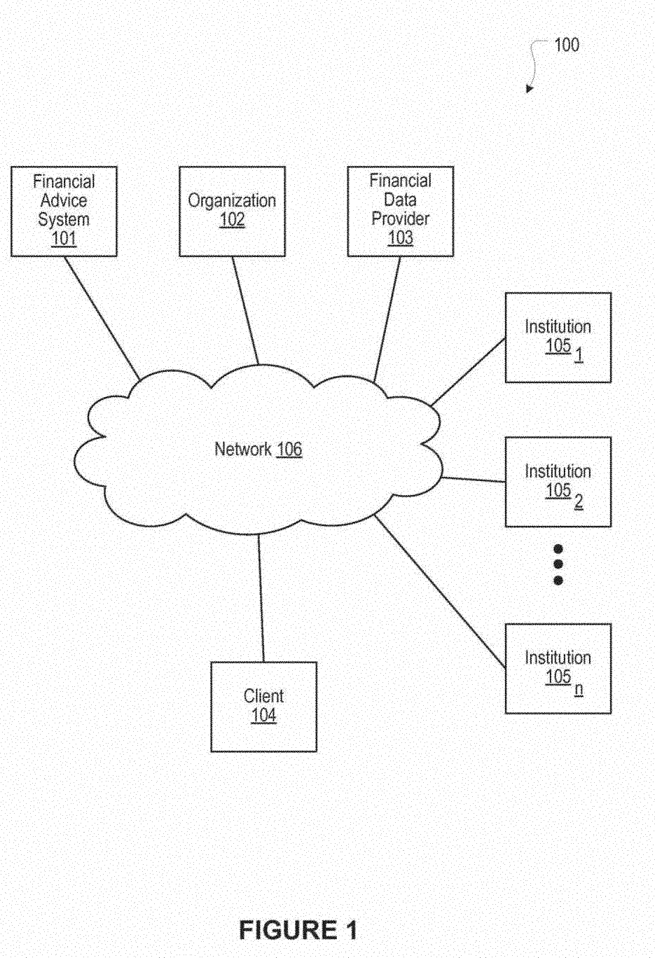

FIG. 1 illustrates an example environment 100 within which some embodiments of the invention may operate. The environment 100 may include a financial advice system 101, an organization 102, a financial data provider 103, a client 104, and institutions 105₁-105ₙ. The institutions 105₁-105ₙ may correspond to banks, credit card companies, brokerage firms, and other entities that receive money or financial information from or about users. In an embodiment, one or more of the institutions 105₁-105ₙ may be a benefits provider. The financial advice system 101, the organization 102, the financial data provider 103, the client 104, and the institutions 105₁-105ₙ may provide and receive data amongst one another via a network 106. In an embodiment, the data may be encrypted.

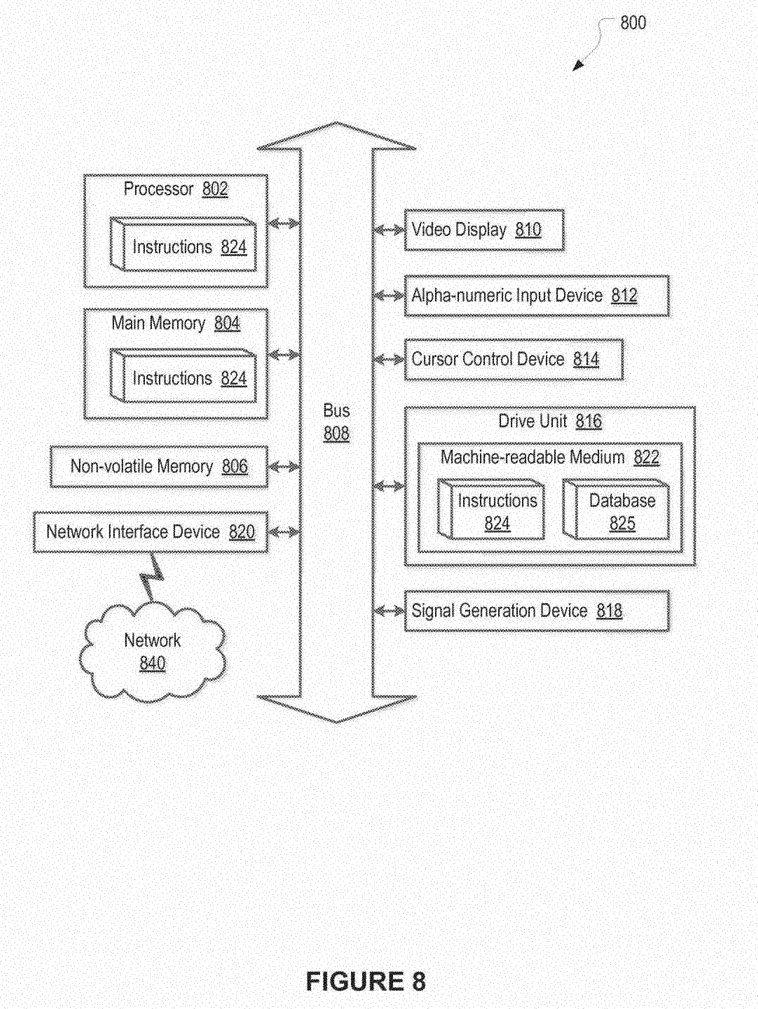

In one embodiment, the network 106 may use standard communications technologies and protocols. Thus, the network 106 may include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 106 may include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 106 may be represented using technologies and/or formats including hypertext markup language (HTML) and extensible markup language (XML). In addition, all or some links may be encrypted using conventional encryption technologies such as secure sockets layer (SSL), transport layer security (TLS), and Internet Protocol security (IPsec). In an embodiment, the financial advice system 101, the organization 102, the financial data provider 103, the client 104, the institutions 105₁-105ₙ, and various combinations or portions thereof may be implemented as machine 800 of FIG. 8 (described in further detail below).

The financial data provider 103 may receive financial data from the institutions 105₁-105ₙ. The financial data may include data related to the user's banks. The data related to the user's banks may include bank names, websites that information related to the user's banks comes from, login field information, and account security requirements (e.g., multi factor authentication, etc.). The financial data may include data related to the user's accounts. The data related to the user's accounts may include account names, account nicknames, account available balances, account current balances, account annual percentage yields (APY), and account minimum payments. The financial data may include data related to the user's transactions. The data related to the user's transactions may include transaction amounts, transaction categories, check numbers, transaction descriptions, transaction memos, and transaction dates. The financial data provider 103 may normalize the financial data. Normalization may include decrypting the data, formatting the data according to a standard format, or other tasks. In an embodiment, the financial data provider 103 may categorize transactions included in the financial data.

In an embodiment, the financial advice system 101 may receive the financial data from the financial data provider 103 and categorize transactions included in the financial data. Categorization may include associating transactions with categories based on the type of transaction. In an embodiment, the financial advice system 101 may categorize transactions that an institution 105ᵢ from which the transaction was received or the financial data provider 103 was unable to categorize. The financial advice system 101 may receive user-provided data from the user.

The organization 102 may be an employer of the user. In an embodiment, the financial advice system 101 may receive organization data from the organization 102. The organization data may include information related to the user, such as the user's salary, age, marital status, or other details. The organization data may include information related to the organization, such as the number of employees, benefits options offered by the employer, human resources administrator, or other details.

According to an embodiment of the invention, financial data and organization data may be received on an ongoing basis. The data may be received as it is updated or at regular intervals. The intervals may be daily, weekly, monthly, quarterly, yearly, or any period of time. In an embodiment, the financial advice system 101 may monitor the data associated with a user for changes, revisions, and modifications. In an embodiment, different data variables within the financial data and the organization data may be received at different intervals. For example, in the organization data, the user's salary may be received on a monthly or quarterly basis and the average FSA balance may be received on an annual basis.

The table below illustrates example organization data. The example organization data relates to information about a company, its benefits offerings, and its employees. The table includes the data variable name, whether the data is related to an employee or the company, and the frequency with which the data is received.

| | Company/ | |
|---|---|---|
| Data Variable | Employee | Frequency Received |
| Number of Employees | Company | Monthly or Quarterly |
| 401(K) Cash Out Number | Company | Monthly or Quarterly |
| 401(K) Loan Number | Company | Monthly or Quarterly |
| Average Monthly Match | Company | Annually |
| Immediate Vesting Share of | Company | Annually |
| Match | | |
| 401(K) Match Contribution | Company | Monthly or Quarterly |
| Spending | | |
| HDHP Participation Rate | Company | Monthly or Quarterly |
| HSA Participation Rate | Company | Monthly or Quarterly |
| HDHP Per-Employee Savings | Company | Annually |
| FSA Participation Rate | Company | Monthly or Quarterly |
| Average FSA Balance | Company | Annually |
| Average Total Compensation | Company | Annually |
| For Workers Ages 20-34, 35- | | |
| 54, 55+ | | |
| Share of Workers Ages 20-34, | Company | Annually |
| 35-54, 55+ | | |
| E-Mail Addresses | Employee | Monthly or Quarterly |
| Home Address | Employee | Monthly or Quarterly |
| Salary | Employee | Monthly or Quarterly |
| Active 401(K) Loan | Employee | Monthly or Quarterly |
| PPO/HMO/HDHP/Other | Employee | Monthly or Quarterly |
| Enrollment | | |
| PPO/HMO/HDHP/Other | Employee | Monthly or Quarterly |
| Eligibility | | |
| 401(K) Eligibility | Employee | Monthly or Quarterly |
| FSA Eligibility | Employee | Monthly or Quarterly |
| HSA Eligibility | Employee | Monthly or Quarterly |
| New Employee List | Company | Monthly or Quarterly |
| Open Enrollment Dates | Company | Annually |
| Name And Contact | Company | Annually |
| Information For HR Benefit | | |
| Questions | | |
| 401(K) Plan Name | Company | Annually |
| Plan Administrator Name | Company | Annually |
| Plan Type (If Other Than | Company | Annually |
| 401(K)) | | |
| Link To Plan Site Where | Company | Annually |
| Elections Can Be Changed | | |
| Plan Allocation Options | Company | Annually |
| 401(K) Eligibility, Deferral Rate, | Employee | Monthly or Quarterly |
| Amount, And Frequency | | |
| 401(K) Loan Value | Employee | Monthly or Quarterly |
| 401(K) Loan Origination Date | Employee | Monthly or Quarterly |
| 401(K) Loan Payoff Date | Employee | Monthly or Quarterly |
| 401(K) Auto Escalation | Employee | Monthly or Quarterly |
| Activated? | | |
| HSA Balance | Employee | Monthly or Quarterly |
| HSA Name | Company | Annually |
| Healthcare Plan Name Options | Company | Annually |
| Healthcare Plan Websites | Company | Annually |
| Healthcare plan Administrators | Company | Annually |
| FSA Name | Company | Annually |
| FSA Eligibility | Company | Annually |
| FSA Administrator | Company | Annually |
| Link To Plan Site | Company | Annually |
| Use By Date | Company | Annually |
| Date of Birth | Employee | Monthly or Quarterly |
| Gender | Employee | Monthly or Quarterly |
| Marital Status | Employee | Monthly or Quarterly |
| Number of Dependents | Employee | Monthly or Quarterly |

Based on the financial data, the user-provided data, and the organization data, the financial advice system 101 may determine responses associated with sub-components and determine values for the user based on the responses. The financial advice system 101 may calculate a score for the user based on the value determined for each sub-component. In an embodiment, the financial advice system 101 may generate an index based on the responses. In an embodiment, the financial advice system 101 may provide recommendations to the user for modifying aspects of his finances based on the user's score and the index.

The financial advice system 101 may receive criteria from the organization 102 and generate aggregated data based on the criteria and a plurality of scores associated with a plurality of users. In an embodiment, the aggregated data may be generated based on the criteria and the financial data. In an embodiment, the aggregated data may be generated based on the criteria and the user-provided data. The aggregated data may be anonymized by removing information that could be used to personally identify individuals within the data. The financial advice system 101 may receive organization data from the organization 102 and generate recommendations based on the organization data and the aggregated data. In an embodiment, the organization 102 may correspond to an employer and the users may be employees of the employer. The recommendations may relate to suggested adjustments to the benefits offered by the employer to the employees. The financial advice system 101 may also provide recommendations for the user including suggestions on how to improve aspects of his finances.

In an embodiment, the client 104 may be a computer system used by a user who has accessed the financial advice system 101 to provide data to the financial advice system 101 or to view his score. In an embodiment, the client 104 may be a computer system used by an employer who has accessed the financial advice system 101 to view aggregated data about its employees.

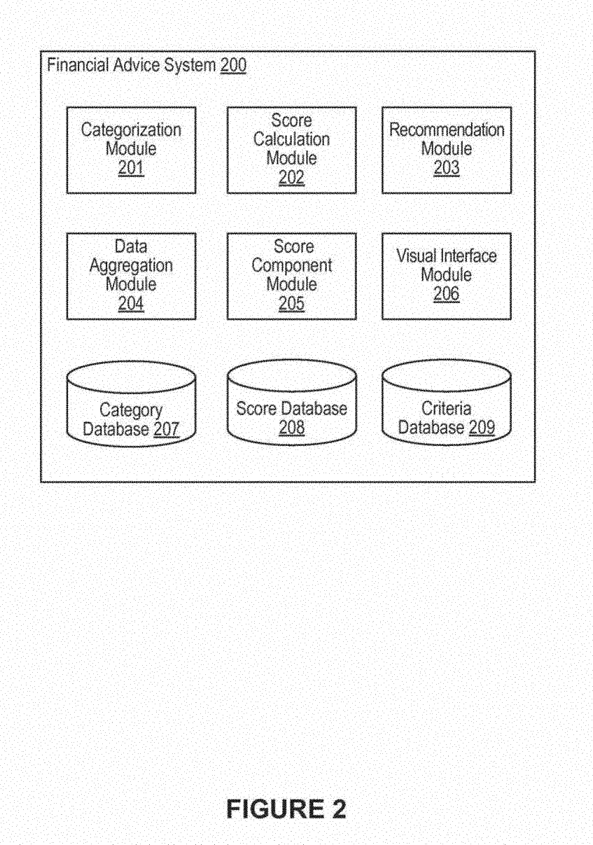

FIG. 2 illustrates an example financial advice system 200 in accordance with an embodiment of the invention. In an embodiment, the financial advice system 101 may include the financial advice system 200. The financial advice system 200 may include a categorization module 201, a score calculation module 202, a recommendation module 203, a data aggregation module 204, a score component module 205, and a visual interface module 206. The financial advice system 200 may also include a category database 207, a score database 208, and a criteria database 209.

The categorization module 201 may receive financial data related to a user from the financial data provider 103. The categorization module 201 may categorize transactions in the financial data. The financial data may include data that the financial data provider 103 did not categorize or was unable to categorize. The transactions may be categorized based on category information stored in the category database 207. The category information may be provided to the financial advice system 200 by users or by another source. Any technique for determining the category information may be used. The categorization module 201 may receive, from a user, category selections associated with transactions that could not be categorized or transactions that were categorized incorrectly. After categorizing transactions in the financial data, the categorization module 201 may provide the financial data to the score calculation module 202.

The score calculation module 202 may receive the financial data from the categorization module 201, organization data from the organization 102, and user-provided data from the user. The score calculation module 202 may determine responses associated with sub-components based on the financial data, the organization data, and the user-provided data. The score calculation module 202 may generate an index based on the responses. The score calculation module 202 may determine values associated with the user for each sub-component based on the responses and the score criteria stored in the criteria database 209, as described in further detail below. The score calculation module 202 may calculate a score for the user based on the values. Scores calculated by the score calculation module 202 may be stored in the score database 208.

The recommendation module 203 may generate recommendations for the user or the employer. The recommendation module 203 may generate recommendations for the user related to suggestions for improving the user's finances based on the user's score and index. The recommendation module 203 may also receive benefits data from the organization 102 or from one or more of the institutions 105₁-105ₙ. The recommendation module 203 may generate benefits recommendations for the organization 102 based on the benefits data and the aggregated data.

The data aggregation module 204 may receive aggregation criteria from the organization 102. The aggregation criteria may include preferences of the financial advice system 101 or the organization 102 regarding how to represent the financial status of certain or all members of the organization 102 collectively. The aggregation criteria may specify the type of information to include in the aggregated data. The aggregation criteria may include specifications related to types of members such as, for example, hourly employees. The aggregation criteria may include specifications related to a type of calculation such as, for example, a mean or an average. The aggregation criteria may include visual specifications that determine how the aggregated data is presented to the organization 102. The organization 102 may require the aggregated data to be in the form of, for example, a pie chart, a bar graph, a list, an x-y plot, or any other visual element for displaying data. The financial advice system 200 may provide the aggregated data to the employer in the visual format requested by the organization 102 in accordance with the aggregation criteria.

Based on the aggregation criteria, the data aggregation module 204 may receive scores from the score database 208. The data aggregation module 204 may generate aggregated data based on the aggregation criteria and the scores received from the score database 208. In an embodiment, the aggregated data may also include data from at least one of the index, the financial data, the organization data, and the user-provided data. In an embodiment, the data aggregation module 204 may anonymize the aggregated data.

The score component module 205 may determine score criteria. The score criteria may be determined based on information received by the financial advice system 200. The information may include statistics, research data, techniques, or any other basis for determining the score criteria. In an embodiment, the score criteria may include selections of score components and weights associated with the score components. In an embodiment, the score criteria may include selections of sub-components associated with the score components and weights associated with the sub-components, as described in further detail below. The score criteria may be stored in the criteria database 209 and provided to the score calculation module 202.

The visual interface module 206 may receive the aggregated data and the aggregation criteria from the aggregation module 204. The visual interface module 206 may, based on the aggregation criteria, generate a visual element representing the aggregated data and provide the visual element to the organization 102 via the client 104. The visual interface module 206 may receive the score and the index from the score calculation module 202, generate a visual element representing the score and the index, and provide the visual element to the user via the client 104. The visual interface module 206 may receive the recommendation from the recommendation module 203, generate a visual element representing the recommendation, and provide the visual element to the organization 102 or the user via the client 104. The visual elements provided by the visual interface module 206 may include bar graphs, pie charts, plots, tables, or any other element for displaying information.

The category database 207 may receive and maintain categories. The categories may be received by the financial advice system 200 from the user or from another source. The category database 207 may provide the categories to the categorization module 201. The score database 208 may receive and maintain scores from the score calculation module 202. The score database 208 may provide a score associated with a user to the user via the client 104. The score database 208 may provide scores to the data aggregation module 204. The criteria database 209 may receive and maintain criteria from the score component module 205. The criteria database 209 may provide the criteria to the score calculation module 202. Any one of the category database 207, the score database 208, and the criteria database 209 may be implemented as a relational database, a flat file database, any other type of database, or any portion or combination thereof.

As described above, according to an embodiment of the invention, a user's score may be determined based on score components. A score component may relate to an aspect of the user's finances. For example, a score component may relate to the user's credit card debt. Other example score components may relate to whether the user has categorized his expenses, the user's spending habits, the user's emergency savings, the user's retirement savings, the user's medical savings, whether the user has set up automated transfers, the user's home equity, the user's other debts, the user's goals, the user's budgeting, the user's awareness of his credit, the user's insurance, and the user's savings for recreational purposes. In an embodiment, score components may be associated with classifications that describe the type of information to which the score components relate. For example, a score component that relates to the user's credit card debt and a score component that relates to the user's home equity may both be associated with a ‘Debt’ classification.

In an embodiment, a score component may be associated with one or more sub-components. The sub-components may relate to details of the user's financial situation. For example, the score component related to a user's credit card debt may have associated sub-components related to whether or not the user has a credit card, the current balance on the user's credit card, whether or not the user has paid interest in the previous three months, or any other factor related to the user's credit card debt. A sub-component may be associated with a response. The response associated with each sub-component may be a Boolean variable, such as whether or not the user has a credit card, or a numeric value, such as the user's current credit card balance.

According to an embodiment of the invention, the responses associated with the sub-components may be determined based on the financial data received from the financial data provider 103, the user-provided data received from the user, or any combination thereof. Any technique for determining the response associated with a sub-component may be used. As described above, the financial data may be received from the financial data provider 103 and include transactions that are categorized by the financial data provider 103, the financial advice system 200, the user, or any combination thereof. The user-provided data may be entered by the user in a survey presented to the user by the financial advice system 200. The survey may include questions about various aspects of the user's finances, to which the user may enter answers. Some questions may be the only basis for a sub-component, such as whether the user has defined and listed his goals, whether the user has listed his assets and debts, whether the user has checked his credit score, whether the user has prioritized his spending, whether the user has created a budget, questions related to the user's insurance information, or any other information related to the user's finances that may not be determined based on the financial data. Answers to some questions may be used in combination with the financial data as the basis for a sub-component, such as questions about the user's age, income, marital status, or number of children.

In an embodiment, the responses associated with the sub-components may change as updated data is received by the financial advice system 200. As described above, data may be received by the financial advice system 200 on an ongoing basis. The data may be received as it is updated or at regular intervals. The data may reflect changes in the user's finances or personal situation. The user's responses associated with the sub-components may be updated accordingly. Because the user's score is determined based on the responses associated with the sub-components, the user's score may change as updated data is received by the financial advice system 200.

According to an embodiment of the invention, a score component and a sub-component may be associated with a weight. The weight may be based on the importance of a score component or sub-component in determining the user's score. In an embodiment, the weights may be determined by the financial advice system 200. In an embodiment, the weights may be received by the financial advice system 200 from an external source. Any technique for determining the weights may be used. The importance of the score component or sub-component may be determined based on historical data, studies related to financial planning, general principles, observations, or any other criteria. For example, a score component (or sub-component) may be given a greater weight based on the difficulty of performing well in the aspect to which the score component (or sub-component) relates and the consequences of performing poorly in the aspect to which the score component (or sub-component) relates. In an embodiment, some or all score components or sub-components may be given the same or different weights. In an embodiment, the selection of weights for score components or sub-components may be based on a classification with which they are associated.

According to an embodiment of the invention, a sub-component may be associated with a maximum value. The maximum value may be based on the weight associated with the sub-component. Similarly, a score component may be associated with a maximum value based on the weight associated with the score component. In an embodiment, the maximum value associated with a score component may be equivalent to the sum of the maximum values associated with each of its sub-components. Any technique for determining the maximum values associated with sub-components and score components may be used.

For each sub-component, an actual value out of the maximum value may be determined for the user based on the response associated with the sub-component. For example, the financial advice system 200 may determine that the user should receive an actual value equivalent to the maximum value for the sub-component related to the user's total credit card debt if the user does not have any credit card debt. The total actual value determined for the user for a score component may be based on the sum of the actual values determined for the user for each of its sub-components. In an embodiment, the maximum value and the value determined for the user may comprise points. A user's score may be determined based on the sum of the values determined for the user for each sub-component and the sum of the maximum values for the sub-components. In an embodiment, the user's score may be a percentage calculated by dividing the sum of the values determined for a user by the sum of the maximum values. The score components, sub-components, the responses associated with the sub-components, and the values determined for the user for each sub-component may collectively comprise an index of the user's finances.

The maximum values associated with score components and sub-components may be periodically adjusted by the financial advice system 200 and may not necessarily represent absolute upper limits on the values determined for the user. Maximum values may change if the financial advice system 200 modifies the weights associated with the score components and sub-components due to, for example, reassessment of the relative importance of score components in determining the user's score or the relative importance of sub-components in determining the value associated with a sub-component. Any basis or technique for determining or adjusting the maximum values may be used.

According to an embodiment of the invention, the financial advice system 200 may use the same score components, sub-components, weights, and maximum values for all users of the financial advice system 200. The financial advice system 200 may determine the score components, sub-components, weights, and maximum values separately from the user scores. For each user, the financial advice system 200 may determine values associated with the same sub-components and score components based on the same maximum values and weights. Consequently, user scores may be standardized and regarded as comparable to one another. For example, a user may determine his financial standing in relation to that of another user by comparing his score with the score of the other user. A user may determine his financial standing relative to all or some other users by comparing his score with an average, a mean, or any other aggregation of multiple scores. Similarly, the organization 102 may assess the collective financial health of all or some of its members based on, for example, an aggregated score because the scores included in the aggregated score were determined based on the same criteria.

According to an embodiment of the invention, values may be determined for the user for a score component or a sub-component based in part on control parameters. A control parameter may refer to a number or a percentage that is held constant for all users of the financial advice system 200. The control parameters may be determined by the financial advice system 200 or received by the financial advice system 200 from an external source. The control parameters may be determined based on research, automated processes, observations, or any other techniques or combinations thereof. Any technique for determining the control parameters may be used. The control parameters may include fixed percentages, assumptions, fixed ratios, or any other factor. In an embodiment, the control parameters may be included in the score criteria.

According to an embodiment of the invention, control parameters may be used to determine targets associated with sub-components. A target may refer to a number associated with a sub-component against which the user's response may be compared. The targets may be determined based on fixed percentages. The value determined for the user for a sub-component may be determined based on a target. For example, the financial advice system 200 may determine targets for sub-components related to the user's credit card balance, balance on other debt, money made available for savings or debt repayment, recreation fund, or insurance coverage based on fixed percentages of the user's annual income. As another example, the financial advice system 200 may determine a target for a sub-component related to the user's home equity based on a fixed percentage of the cost or value of the home. As yet another example, the financial advice system 200 may determine a target for a sub-component related to the user's transactions left uncategorized as a fixed percentage of the user's total number of transactions. In an embodiment, targets may be determined based on other factors. For example, the financial advice system 200 may determine a target for a sub-component related to the number of months of emergency savings the user has based on whether the user owns a house or a car. In an embodiment, the financial advice system 200 may determine values for the users for the sub-components based on how the responses associated with the sub-components compare to the targets associated with the sub-components.

According to an embodiment of the invention, control parameters may be used to determine penalty thresholds associated with sub-components. A penalty threshold may refer to a threshold value for which the financial advice system 200 determines that a zero value should be determined for the user for a sub-component. In an embodiment, the financial advice system 200 may determine that a zero value should be determined for the user for a sub-component if the user's response associated with the sub-component exceeds the penalty threshold. In an embodiment, the financial advice system 200 may determine that a zero value should be determined for the user for a sub-component if the user's response associated with the sub-component falls below the penalty threshold. The penalty thresholds may be determined based on fixed percentages.

For example, the financial advice system 200 may determine penalty thresholds for sub-components related to the user's credit card balance and balance on other debts based on fixed percentages of the user's income. In an embodiment, if the user's credit card balance or balance on other debts comprises a percentage of the user's income that exceeds a credit card penalty threshold or an other debts penalty threshold, then the financial advice system 200 may determine zero values for the user for the sub-components related to the users credit card balance and the balance on his other debts, respectively. As another example, the financial advice system 200 may determine a penalty threshold for the home equity of the user based on a fixed percentage of the cost or value of the user's home. In an embodiment, if the user's home equity comprises a percentage of the cost or value of his home that falls below a home equity penalty threshold, then the financial advice system 200 may determine a zero value for the user for the sub-component related to the user's home equity. As yet another example, the financial advice system 200 may determine a penalty threshold for the users transactions left uncategorized as a fixed percentage of the user's total number of transactions. In an embodiment, if the user's uncategorized transactions comprise a percentage of the user's total transactions that exceeds an uncategorized transactions penalty threshold, then the financial advice system 200 may determine a zero value for the user for the sub-component related to uncategorized transactions.

In an embodiment, control parameters may include assumptions, fixed ratios, or any combination thereof. Assumptions may include wage inflation rates, retirement earnings rates, starting ages for contributing to retirement savings accounts, income replacement ratios, average retirement ages, average life expectancies, and average health insurance costs. Fixed ratios may include social security income replacement ratios. The assumptions and fixed ratios may be determined by the financial advice system 200 or received from an external source. For example, data relating to retirement ages, average life expectancies, and income replacement ratios may be received from the United States Social Security Administration. As another example, the health insurance costs may be received from insurance companies.

According to an embodiment of the invention, the financial advice system 200 may provide recommendations based on the user's index and score. Creating an index and determining a score for a user may reveal weaknesses or deficiencies in the user's finances that may be addressed. For example, the user's index may reveal that the user has been contributing a default amount set by his employer to his retirement savings account despite not having a sufficient amount of money saved for emergencies. The user's score may have been lowered as a result. The financial advice system 200 may recommend, for example, that the user decrease his monthly contribution to his retirement savings account and instead allocate the money to emergency savings.

According to an embodiment of the invention, the financial advice system 200 may suggest corrective action to address weaknesses in the user's finances. The corrective action may include specific steps that the user is recommended to undertake such as, for example, depositing a portion of his paycheck in a health savings account (HSA) if the user has a high amount of health expenses. The corrective action may include general advice such as, for example, a suggestion that the user reduce his credit card debt. In an embodiment, the corrective action may be related to weaknesses in the user's finances that are having the greatest effect in lowering the user's score.

In an embodiment, the financial advice system 200 may provide recommendations to the organization 102 based on the aggregated data. The aggregated data may reveal that the organization 102 is not providing benefits to its members in an optimal manner. For example, the aggregated data may reveal that the majority of employees of an employer are contributing the default amount to their retirement savings accounts irrespective of their financial situation. The financial advice system 200 may recommend, for example, that the default contribution be modified or eliminated and provide financial counseling to employees before they decide how much money to contribute to their retirement savings accounts.

According to an embodiment of the invention, the financial advice system 200 may aggregate the scores, the financial data, the user-provided data, or any combination thereof for the employer. The employer may wish to determine the overall financial standing of its employees in order to make informed decisions about its benefits offerings. For example, the employer may wish to identify which of the benefits are not useful or helpful to the employees and cancel these benefits. In an embodiment, the employer may specify criteria for aggregating scores and financial data. The criteria may, for example, specify a particular pay grade, age range, seniority level, or other subset of employees. The criteria may include all or select employees. The criteria may specify that the employer wishes to see the average or mean score of a subset of employees. Any criteria may be used. The financial advice system 200 may aggregate the scores, the financial data, or the user-provided data in accordance with the criteria.

In an embodiment, prior to providing the aggregated data to the employer, the financial advice system 200 may remove all identifying information from the aggregated data. The aggregated data may include sensitive information or personal details that the employer could potentially use to identify employees. To protect employees' privacy, the aggregated data may be anonymized such that the employer may only see, for example, an average score, percentages of employees, or grand totals.

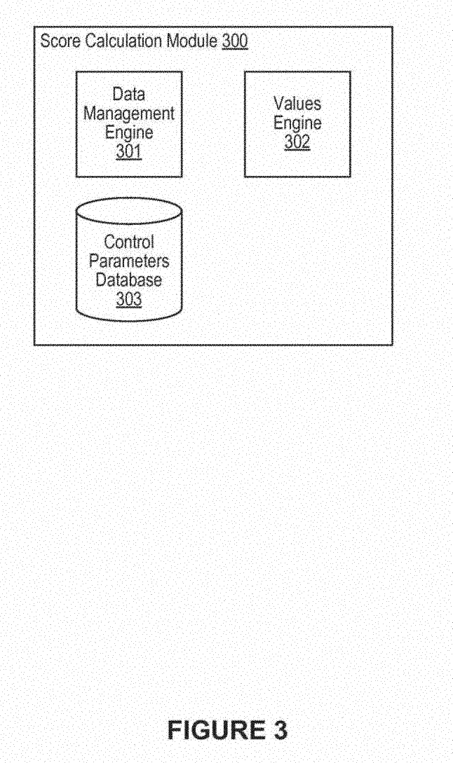

FIG. 3 illustrates an example score calculation module 300 in accordance with an embodiment of the invention. In an embodiment, the score calculation module 202 may include the score calculation module 300. The score calculation module 300 includes a data management engine 301, a values engine 302, and a control parameters database 303.

The data management engine 301 may receive financial data from the categorization module 201 or the financial data provider 103, user-provided data from the user, and score criteria from the score component module 205. The data management engine 301 may determine the score components and sub-components included in the score criteria. The data management engine 301 may associate responses with the sub-components based on the financial data and the user-provided data.

The values engine 302 may receive the responses from the data management engine 301 and score criteria from the score component module 205. The values engine 302 may determine maximum possible values for the score components and sub-components based on the score criteria. The values engine 302 may determine values for the user based on the responses and the maximum values associated with the score components and the sub-components. In an embodiment, the values engine 302 may receive the score criteria from the score component module 205, determine designations of control parameters included in the score criteria, and receive the control parameters from the control parameters database 303 based on the designations. The values engine 302 may determine values for the user based further on the control parameters received from the control parameters database 303. The values engine 302 may determine a score associated with the user based on the values determined for the user. The values engine 302 may provide the score to the score database 208.

The control parameters database 303 may store control parameters received or determined by the financial advice system 200. The control parameters may be determined manually, by an automated process, or based on pre-determined criteria. The control parameters database 303 may provide the control parameters to the values engine 302.

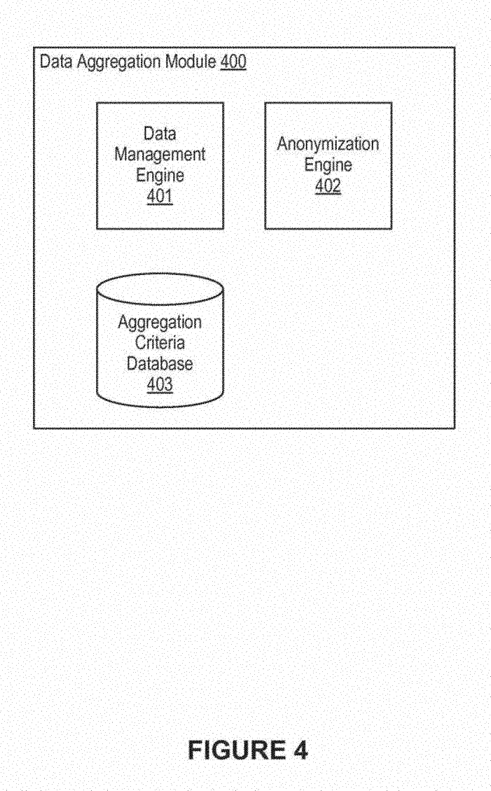

FIG. 4 illustrates an example data aggregation module 400 in accordance with an embodiment of the invention. In an embodiment, the data aggregation module 204 may include the data aggregation module 400. The data aggregation module 400 includes a data management engine 401, an anonymization engine 402, and an aggregation criteria database 403.

The data management engine 401 may receive aggregation criteria from the organization 102. The aggregation criteria may specify which scores and data to aggregate, as described in further detail above. Based on the aggregation criteria, the data management engine 401 may receive scores from the score database 208, user-provided data from the score calculation module 300, financial data from the financial data provider 103, or any combination thereof. The data management engine 401 may store the aggregation criteria in the aggregation criteria database 403. The data management engine 401 may provide the scores and the data to the anonymization engine 402. The data management module 401 may provide the aggregation criteria to the visual interface module 206.

The anonymization engine 402 may receive data from the data management engine 401. The anonymization engine 402 may anonymize the scores and the data. In an embodiment, the anonymization engine 402 may anonymize the scores and the data by removing all information from the scores and the data that would allow the organization 102, a user, or any other entity to identify specific users. After anonymizing the data, the anonymization engine 402 may provide the anonymized data to the visual interface module 206. The aggregation criteria database 403 may receive the aggregation criteria from the data management engine 401. The aggregation criteria may be stored in the aggregation database 403 for future reference if the organization 102 wishes to repeat an aggregation. For example, the organization 102 may be presented with and given the option to select previously specified aggregation criteria to avoid the inconvenience of having to specify the same aggregation criteria multiple times.

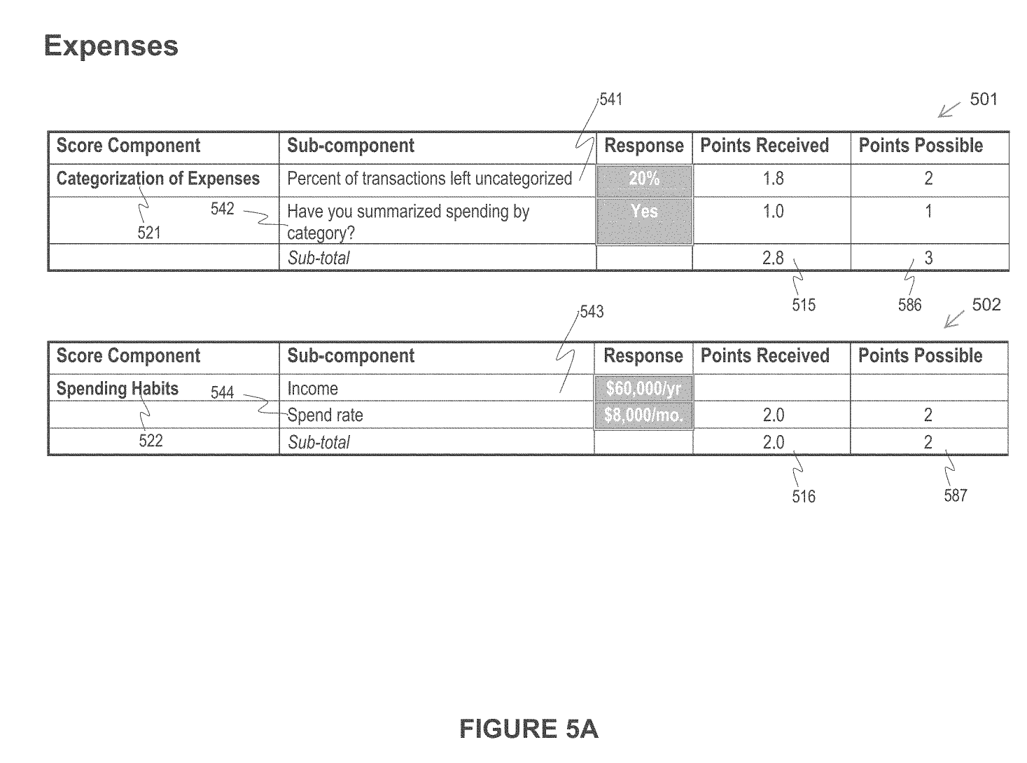

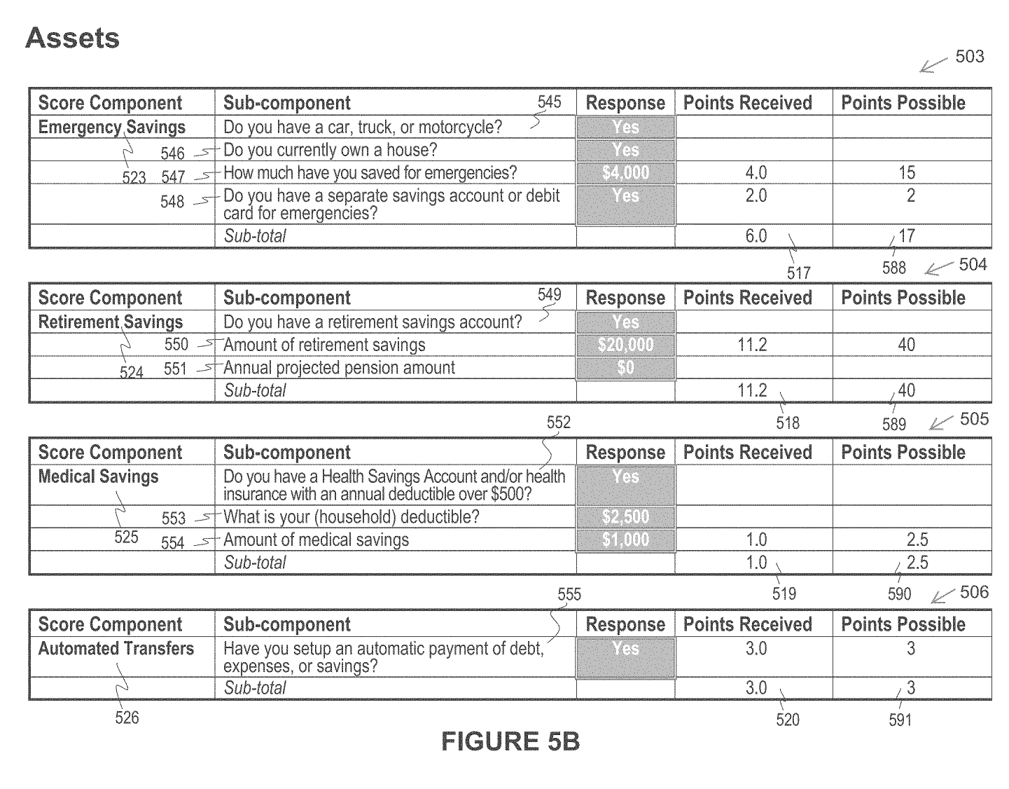

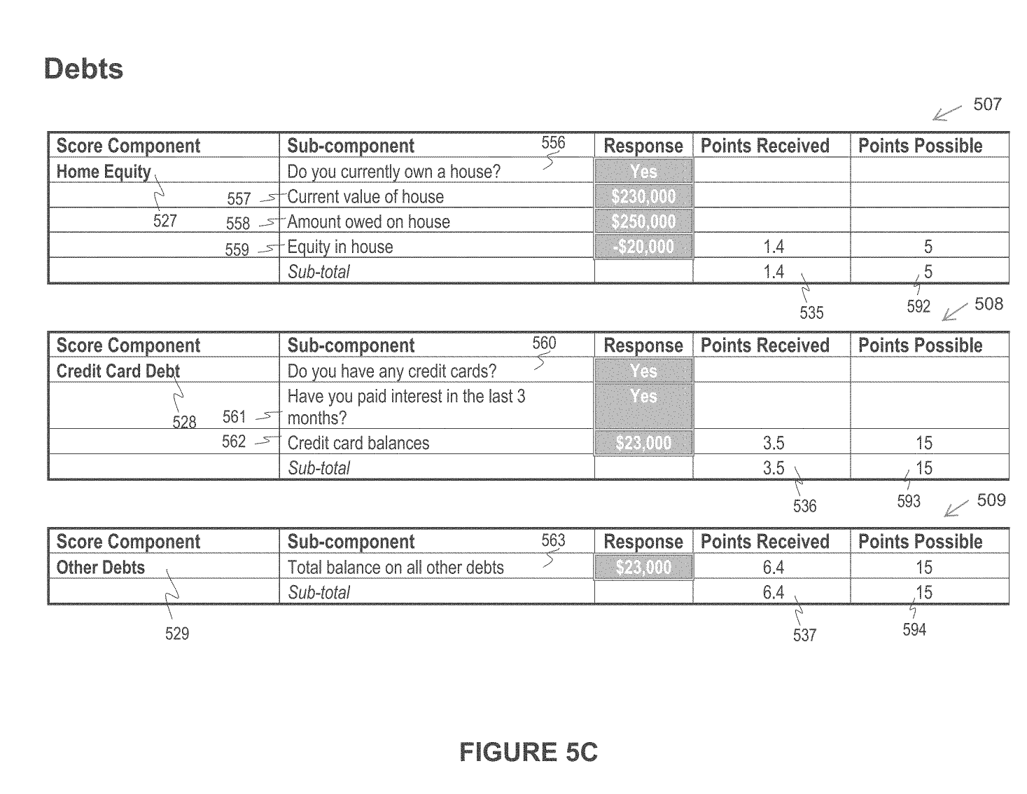

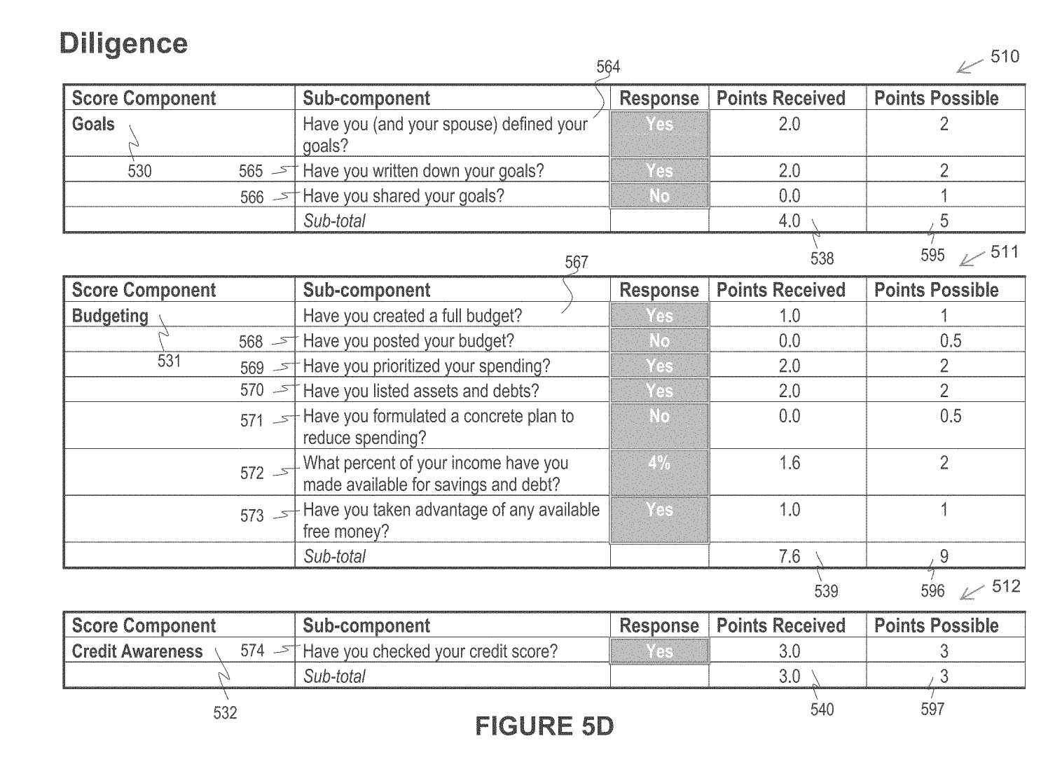

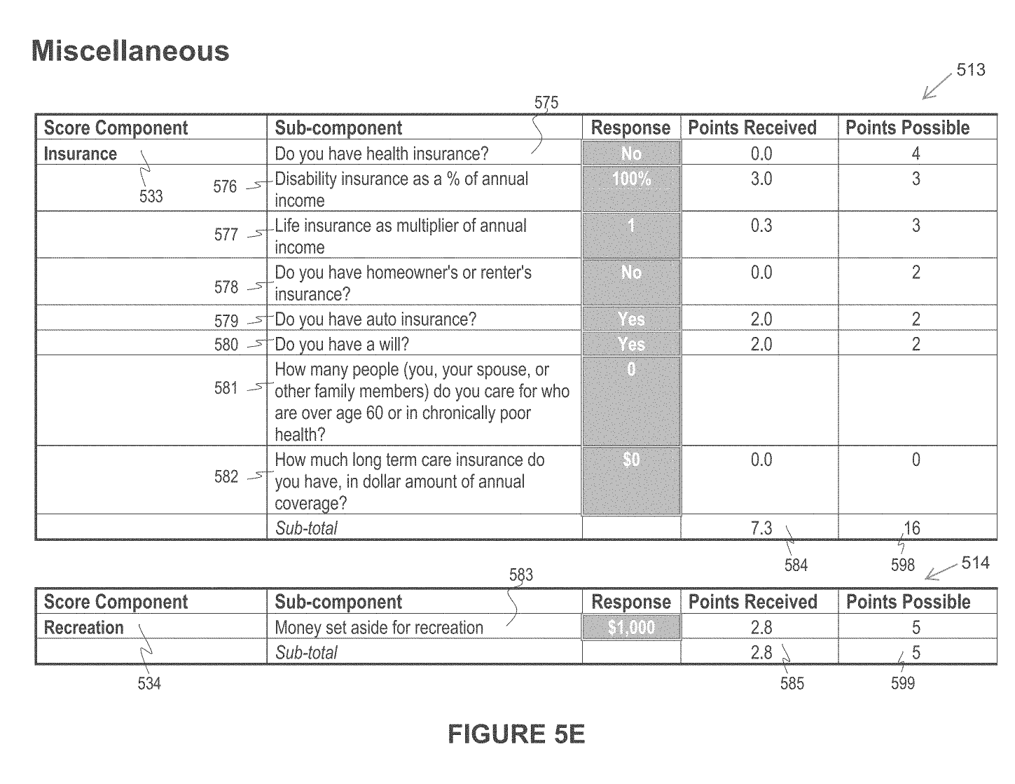

FIGS. 5A-5E depict tables 501-514 illustrating an example index with example classifications, score components, and sub-components in accordance with an embodiment of the invention. The example index includes data for a hypothetical 35-year old user earning $60,000 a year. In the example index, each score component is associated with a classification and each sub-component is associated with a score component. Each sub-component has an associated response determined based on the user's financial data or data provided by the user. The values determined for the user and the maximum values are expressed as points received and points possible, respectively.

Tables 501 and 502 of FIG. 5A illustrate score components 521 and 522, respectively, associated with an ‘Expenses’ classification. Sensible spending and awareness of expenses may be seen as indicators of financial stability and preparedness. As shown in tables 501 and 502, score components 521 and 522 may relate to categorization of the user's expenses and the user's spending, respectively.

The ‘Categorization of Expenses’ score component 521 may relate to the extent to which a user has categorized his transactions. The financial advice system 200 may determine the user's expenses based on the user's transactions received from the financial data provider 103. As discussed above, the financial data provider 103 or the financial advice system 200 may categorize a user's transactions. Some transactions may be easily categorized based on, for example, the name of a well-known merchant associated with the transaction. Other transactions may be difficult or impossible to categorize because, for example, the name of the merchant is unknown, ambiguous, or obscure. These transactions may be left uncategorized. Transactions may also have been categorized incorrectly by the financial data provider 103 or the financial advice system 200.

According to an embodiment of the invention, the user may categorize the uncategorized transactions manually by selecting from pre-defined categories or by specifying a category. The user may also re-categorize transactions that have been categorized incorrectly. If too many transactions have been left uncategorized or the user has not verified that transactions have been categorized correctly, then the financial advice system 200 may determine that the user should receive relatively few points because it may be difficult to determine how the user is spending his money. As shown in the table 501, sub-components 541 and 542 associated with the ‘Categorization of Expenses’ score component 521 may relate to the percentage of the user's transactions that have been left uncategorized and whether the user has summarized his spending by category, respectively.

The ‘Spending Habits’ score component 522 may relate to the user's spending and the rate at which the user spends his money relative to his income. The financial advice system 200 may determine a spend rate of the user based on the user's transactions and their associated categories over a designated interval of time such as, for example, one month or two months. In an embodiment, the financial advice system 200 may determine the users income based on his bank account history included in the financial data received from the financial data provider 103. In an embodiment, the financial advice system 200 may determine the user's income based on data received from the organization 102, which may be the user's employer. In an embodiment, the financial advice system 200 may determine the user's income based on the user-provided data. Any technique for determining the user's income may be used. The financial advice system 200 may determine the budget the user has allocated for different types of expenses. As shown in the table 502, sub-components 543 and 544 associated with the score component 522 may relate to the user's income and his spend rate, respectively. Additional examples of sub-components may relate to the user's budget, whether the user spends less than he earns in income, the percentage of the user's income that he does not spend, or any other factor or combination thereof.

Tables 503-506 of FIG. 5B illustrate score components 523-526 associated with an ‘Assets’ classification. Taking stock of a user's assets may be crucial to evaluating the user's finances. Well-tracked and well-allocated assets may be seen as an indicator of financial stability and preparedness. As shown in tables 503, 504, 505, and 506, score components 523, 524, 525, and 526 associated with the ‘Assets’ classification may relate to the user's emergency savings, retirement savings, medical savings, and automated transfers, respectively.

The ‘Emergency Savings’ score component 523 may relate to money the user has set aside for unexpected financial losses such as, for example, the loss of a job. In an embodiment, adequacy of emergency savings may be determined based on, for example, whether the user has saved three to six months of income that may be used to support him if he loses his job. Adequacy of emergency savings may also be determined based on whether the user owns a vehicle or a home. As shown in the table 503, sub-components 545, 546, 547, and 548 associated with the ‘Emergency Savings’ score component 523 may relate to whether the user owns a car, truck, or motorcycle; whether the user owns a house; how much the user has saved for emergencies; and whether the user has a separate savings account or debit card for emergencies, respectively.

The ‘Retirement Savings’ score component 524 may relate to money the user has set aside to support himself when he retires. The financial advice system 200 may identify funds that the user has set aside for retirement by determining the user's balances in retirement savings accounts such as Individual Retirement Arrangement (IRA) accounts, 401(k) accounts, 403(b) accounts, or any other type of account associated with retirement savings. The financial advice system 200 may also count the user's available cash and extra savings that are not needed for expenses or debts as retirement savings. In an embodiment, the sufficiency of the user's retirement savings may be determined according to the user's age, the user's income, the users assets, or any other aspect of the user's finances or personal situation. As shown in the table 504, sub-components 549, 550, and 551 associated with the ‘Retirement Savings’ score component 524 may relate to whether the user has a retirement savings account, the amount of the user's retirement savings, and the user's projected pension amount, respectively.

The ‘Medical Savings’ score component 525 may relate to money the user has set aside for unexpected medical expenses. Planning for expenses related to medical care arising from an unexpected injury or ailment may be seen as an indicator of financial preparedness and stability. Some employers may offer health savings accounts (HSA), a special type of bank account in which a user may deposit a portion of his paycheck before income taxes are assessed. The money in an HSA may typically be spent only on medical expenses. Similarly, some employers may provide different types of health insurance with varying deductibles. As shown in the table 505, sub-components 552, 553, and 554 associated with the ‘Medical Savings’ score component 525 may relate to whether the user has an HSA or health insurance with an annual deductible of $500, the user's insurance deductible, and the amount of the user's medical savings, respectively.

The ‘Automated Transfers’ score component 526 may relate to automatic transfers of funds that the user has set up. Banks and financial institutions may allow their customers to automatically transfer a fixed amount of money at designated intervals between, for example, checking and savings accounts. Similarly, banks and financial institutions may allow their customers to set up automatic monthly payments for bills or debts. Utilization of such transfers may be seen by behavioral scientists as an indicator of financial preparedness and stability. As shown in the table 506, the sub-component 555 associated with the ‘Automated Transfers’ score component 526 may relate to whether the user has set up automated payments of debt, expenses, or savings.

Tables 507-509 of FIG. 5C illustrate score components 527-529 associated with a ‘Debts’ classification. The ‘Debts’ classification may relate to how much debt a user has. Low debt may be seen as an indicator of financial preparedness or stability. As shown in tables 507, 508, and 509, score components 527, 528, and 529 associated with the ‘Debts’ classification may relate to the user's home equity, credit card debt, and other debt, respectively.

The ‘Home Equity’ score component 527 may relate to the amount of equity the user has in his home. Having a low mortgage balance and a high amount of home equity may be seen as an indicator of financial preparedness and stability. In an embodiment, having a mortgage with a down payment of at least 20% of the home's cost may be viewed positively by the financial advice system 200. In an embodiment, having a mortgage balance that is higher than the value of the home (i.e., the home is “under water”) may be viewed negatively by the financial advice system 200. As shown in the table 507, sub-components 556, 557, 558, and 559 associated with the ‘Home Equity’ score component 527 may relate to whether or not the user is a homeowner, the current value of the user's house, the amount owed on the house, and the user's equity in the house, respectively.

The ‘Credit Card Debt’ score component 528 may relate to revolving lines of credit the user has from banks, credit unions, retail outlets, or any other institution. The user's credit card debt may be determined based on, for example, whether the user has enough available cash to pay off his credit card balances, the difference between his available cash and his credit card balances, how long the user's inability to pay off his balances has persisted, or any other factor or combination thereof. In an embodiment, the financial advice system 200 may assign the maximum number of points if the user does not have a credit card or if the user does not have any credit card debt. As shown in the table 508, sub-components 560, 561, and 562 associated with the ‘Credit Card Debt’ score component 528 may relate to whether or not the user has a credit card, whether or not the user has paid interest in the past three months, and the total amount of the user's credit card balances, respectively.

The ‘Other Debts’ score component 529 may relate to car loans, student loans, personal loans, or any other type of loan not accounted for in the ‘Credit Card Debt’ score component 528 or the ‘Home Equity’ score component 527. In an embodiment, the ‘Other Debts’ score component 529 and its sub-components may have a lower weight than the ‘Credit Card Debt’ score component 528 and the ‘Home Equity’ score component 527 based on, for example, observations that such debt may not be as detrimental to a user's financial stability and preparedness as credit card debt. As shown in the table 509, the sub-component 563 associated with the ‘Other Debts’ score component 529 may relate to the total balance on the user's other debts.

Tables 510-512 of FIG. 5D illustrate score components 530-532 associated with a ‘Diligence’ classification. The ‘Diligence’ classification may relate to the level of diligence the user has done on his own related to his financial situation. In an embodiment, the responses associated with sub-components of the score components 530-532 in the ‘Diligence’ classification may be determined based on user-provided data. As shown in tables 510, 511, and 512, the score components 530, 531, and 532 associated with the ‘Diligence’ classification may relate to the user's goals, the user's budgeting, and the user's awareness of his credit, respectively.

The ‘Goals’ score component 530 may relate to future expectations that the user has related to his finances and objectives that he hopes to achieve. Formulating financial goals and expectations and keeping track of the goals and expectations may be seen as an indicator of financial stability and preparedness. As shown in the table 510, sub-components 564, 565, and 566 associated with the ‘Goals’ score component 530 may relate to whether or not the user has defined his goals, whether or not the user has written down his goals, and whether or not the user has shared his goals, respectively.

The ‘Budgeting’ score component 531 may relate to the user's allocation of money to different types of expenses. Formulating a monthly or yearly budget may be seen as an indicator of financial stability and preparedness. In an embodiment, the user's use of opportunities to receive free money, such as 401(k) matching funds provided by an employer, may also be related to budgeting. As shown in the table 511, sub-components 567, 568, 569, 570, 571, 572, and 573 associated with the ‘Budgeting’ score component 531 may relate to whether or not the user has created a full budget, whether or not the user has posted his budget to the financial advice system 200, whether or not the user has prioritized his spending, whether or not the user has listed his assets and debts, whether the user has formulated a concrete plan to reduce spending, what percentage of his income the user has made available for savings and debt, and whether the user has taken advantage of available free money, respectively.

The ‘Credit Awareness’ score component 532 may relate to the user's knowledge of his credit score and how often he checks his credit score. Being conscious of personal credit rating and keeping track of credit scores may be seen as an indicator of financial preparedness and stability. As shown in the table 512, sub-component 574 associated with the ‘Credit Awareness’ score component 532 may relate to whether or not the user has checked his credit score.

Tables 513 and 514 of FIGURE SE illustrate score components 533 and 534, respectively, associated with a ‘Miscellaneous’ classification. The ‘Miscellaneous’ classification may relate to other score components that are unrelated to expenses, assets, debts, or diligence. Some score components may relate to important aspects of a user's financial stability and preparedness, but may not fit within any of the other classifications. As shown in tables 513 and 514, the score components 533 and 534 associated with the ‘Miscellaneous’ classification may relate to insurance and recreation, respectively.

The ‘Insurance’ score component 533 may relate to the types of insurance a user has and his level of coverage. Having an appropriate amount of insurance coverage may be regarded as an indicator of financial preparedness and stability. Types of insurance may include health insurance, disability insurance, life insurance, renter's insurance, homeowner's insurance, auto insurance, long term care insurance, or any other form of insurance. In an embodiment, the user's will and testament may also be considered as a type of insurance. The financial advice system 200 may determine the user's types of insurance and level of insurance coverage based on the user-provided data or the financial data received from the financial data provider 103. Any technique for determining the user's types of insurance and level of insurance coverage may be used. In an embodiment, some forms of insurance may be considered unnecessary based on the user's personal situation. For example, if the user is unmarried and does not have children, life insurance may be deemed unnecessary. If the user is married or has children, then a certain level of coverage may be viewed positively by the financial advice system 200.

According to an embodiment of the invention, the adequacy of the user's insurance coverage may be determined on the basis of sufficiency thresholds. A sufficiency threshold may be based on, for example, a percentage or multiplier of the user's income for disability insurance or life insurance, respectively. In an embodiment, responses associated with sub-components of the ‘Insurance’ score component 533 may be determined based on user-provided data. As shown in the table 513, sub-components 575, 576, 577, 578, 579, 580, 581, and 582 associated with the ‘Insurance’ score component 533 may relate to whether the user has health insurance, the amount of disability insurance the user has as a percentage of his income, the amount of life insurance the user has as a percentage of his income, whether the user has homeowner's or renter's insurance, whether the user has a will, how many people the user cares for who are over age 60 or in chronically poor health, and how much long term care coverage the user has in a dollar amount of annual coverage, respectively.

The ‘Recreation’ score component 534 may relate to money that the user has set aside for recreational purposes such as, for example, vacations. Setting aside an appropriate amount of money for recreation may be regarded as a sign of financial preparedness and stability. The financial advice system 200 may determine what an appropriate amount is based on the user's income, emergency savings, retirement savings, age, marital status, number of children, or any other factor or combination thereof. As shown in the table 514, sub-component 583 associated with the ‘Recreation’ score component 534 may relate to the amount of money the user has set aside for recreation.

The classifications, score components, and sub-components illustrated in the index of FIGS. 5A-5E are provided by way of example. Score components may be associated with any classification or classifications. Users' scores may be determined based on any number or type of score components or combinations thereof. A score component may be associated with any number and type of sub-components or combinations thereof. The classifications and the number and type of score components and sub-components may be determined by the financial advice system 200 based on any criteria, or received by the financial advice system 200 from an external source. Any technique for determining classifications and the number and type of score components and sub-components may be used.

According to an embodiment of the invention, the value determined for a user for a sub-component may be determined based on formulae that incorporate the response associated with the sub-component and one or more control parameters. For example, returning to the table 501 of FIG. 5A, the financial advice system 200 may determine that the user should receive a number of points for the sub-component 541 related to his percentage of uncategorized transactions based on a percentage N. The percentage N may be calculated based on the formula:

N=(1−(Y−U))÷(G−U),

where Y is the user's percentage of uncategorized transactions, U is a target for the user's uncategorized transactions, and G is a penalty threshold for the user's uncategorized transactions. In the current example, the user's percentage of uncategorized transactions Y is 20% as shown in the sub-component 541 in the table 501. U and G may be given as control parameters. In the present example, U=10% and G=100%. Therefore,

N=1−((20%−10%)÷(100%−10%))=88.9%.

As shown in the table 501, the maximum number of points for the sub-component 541 related to the user's uncategorized expenses is 2. Because 88.9% of 2 is 1.8, the user receives 1.8 points.

As another example, returning to the table 503 of FIG. 5B, the financial advice system 200 may determine that the user should receive a number of points for the sub-component 547 related to the user's emergency savings based on a percentage K. The percentage K may be calculated based on the formula:

K=D÷(X×V÷12)×100%,

where D is the user's total emergency savings, X is the user's average monthly expenses, and V is a target number of months of emergency savings the user may require. In the current example, the user's total emergency savings D is $4,000, as shown in the sub-component 547 in the table 503. In the current example, the user's average monthly expenses X are $45,000. V may be given as a control parameter. In the current example, V is 4. Therefore,

K=$4,000÷($45,000×4÷12)×100%=26.7%

As shown in the table 503, the maximum number of points for the sub-component 547 related to the user's total emergency savings is 15. Because 26.7% of 15 is 4, the user receives 4 points.

As another example, returning to the table 504 of FIG. 5B, the financial advice system 200 may determine that the user should receive a number of points for the sub-component 550 related to the user's retirement savings based on a percentage P. The percentage P may be calculated based on the formula:

P=Z÷B,

where Z is the user's total retirement savings and B is a sufficient amount of retirement savings for the user's current age. As shown the sub-component 550 in the table 504, the user's total retirement savings Z is $20,000. The sufficient amount B may be calculated based on the formula:

B=C×((1+E)^{Y}^{_{A}}−1)÷E,

where C is the user's required annual contribution to his retirement savings. E is a retirement earnings rate, and Y_{A} is the number of years the user has made contributions to date. E may be given as a control parameter. In the current example, E=6%. Y_{A} may be determined as the difference between the user's current age and the user's age A when he started making contributions to his retirement savings. In the current example, the user is 35 years old and began making contributions to his retirement savings at age 18, so 35-18=17.

C may be calculated based on the formula:

C=(T_{R}×E)÷((1+E)^{Y}^{_{C}}−1),

where T_{R} is the future value of the amount of money the user will need after accounting for Social Security payouts and Y_{C} is the number of years the user must make contributions to his retirement savings. Y_{C} may be determined as one plus the difference between the user's expected retirement age and the user's starting age for contributions A, so Y_{C}=1+65−18=48.

T_{R} may be calculated based on the formula:

T_{R}=I×(R−S)×Y_{L}×(1+W)^{Y}^{_{R}},

where I is the user's income, R is an income replacement ratio, S is the user's expected Social Security payout as a percentage of retirement income, Y_{L} is the number of years the user is expected to live after retirement, W is a wage inflation rate, and Y_{R} is the number of years the user has left before retirement. In the current example, the user's income I is $60,000 as shown in the sub-component 543 in the table 502 of FIG. 5A. R may be given as a control parameter. In the current example, R=80%. S may be determined based on control parameters received from the Social Security Administration. In the current example, S is 44.764564%. Y_{L} may be determined as the difference between the user's life expectancy and the user's expected retirement age, which may be given as control parameters. If the user's life expectancy is 82 years and the user's expected retirement age is 65, then Y_{L}=82−65=17. Therefore,

T_{R}=$60,000×(80%−44.764564%)×17×(1+2%)³⁰=$651,005.97,

C=($651,005.97×6%)÷((1+6%)⁴⁸−1)=$2,537.40, and

B=$2,537.40×((1+6%)¹⁷−1))÷6%=$71,587.36.

The percentage P that that the user's retirement savings comprises of the sufficient amount B is P=$20,000÷$71,587.36=27.9%. As shown in the sub-component 550 in the table 504, the maximum number of possible points for the sub-component related to the amount of the user's retirement savings is 40. Because 27.9% of 40 is 11.2, the user receives 11.2 points.

As another example, returning to the table 505 of FIG. 5B, the financial advice system 200 may determine that the user should receive a number of points for the sub-component 554 related to the user's medical savings based on a percentage Q. The percentage Q may be calculated based on the formula:

Q=L÷O.

where L is the user's medical savings and O is the user's health insurance deductible. As shown in the sub-component 554 in the table 505, the user's total medical savings L is $1,000 and his deductible O is $2,500. Thus,

Q=$1,000÷$2,500=40%.

As shown in the table 505, the maximum number of possible points for the sub-component 554 related to the total amount of the user's medical savings is 2.5. Because 40% of 2.5 is 1, the user receives 1 point.

As another example, returning to the table 508 of FIG. 5C, the financial advice system 200 may determine that the user should receive a number of points for the sub-component 562 related to the user's total credit card balances based on a percentage p. The percentage p may be calculated based on the formula:

p=1−((b÷l−d)÷(q−d))

where b is the user's total credit card debt, l is the user's income, d is an ideal credit card balance as a percentage of income, and q is a penalty threshold for credit card debt as a percentage of income. As shown in the sub-component 562 in the table 508, the user's total credit card debt is $23,000. In the current example, the user's income I is $60,000. d and q may be given as control parameters. In the current example, d=0% and q=50%. Therefore,

p=1−(($23,000÷$60,000−0%)÷(50%−0%))=23.3%.

As shown in the table 508, the maximum number of possible points for the sub-component 562 related to the user's total credit card balance is 15. Because 23.3% of 15 is 3.5, the user receives 3.5 points.

As another example, returning to the table 509 of FIG. 5C, the financial advice system 200 may determine that the user should receive a number of points for the sub-component 563 related to the user's total balance on other debts based on a percentage g. The percentage g may be calculated based on the formula:

g=1−((t÷l−u)÷(w−u))

where t is the user's total other debt, l is the user's income, u is an ideal other debt balance as a percentage of income, and w is a penalty threshold for other debt as a percentage of income. As shown in the sub-component 529 in the table 508, the user's total other debt is $23,000. In the current example, the user's income l is $60,000. u and w may be given as control parameters. In the current example, u=0% and q=66.7%. Therefore,

g=(1−(($23,000÷$60,000−0%)÷(66.7%−0%))×100%=42.5%.

As shown in the table 508, the maximum number of possible points for the sub-component 563 related to the user's total credit card balance is 15. Because 42.5% of 15 is 6.4, the user receives 6.4 points.

As another example, returning to the table 511 of FIG. 5D, the financial advice system 200 may determine that the user should receive a number of points for the sub-component 572 based on the percentage f. The percentage f may be calculated based on the formula:

f=n÷k.

where n is the percentage of the user's income that he has made available for savings and debt and k is an ideal percentage of income that should be made available for savings and debt. As shown in the sub-component 572 in the table 511, the percentage of the user's income n that he has made available for savings and debt is 4%. k may be given as a control parameter. In the current example, k=5%. Therefore:

f=4%÷5%=80%.

As shown in the sub-component 572 in the table 511, the maximum number of possible points for the sub-component 572 related to the percentage of the user's income he has made available for savings and debt is 2. Because 80% of 2 is 1.6, the user receives 1.6 points.

As another example, returning to the table 514 of FIG. 5E, the financial advice system 200 may determine that the user should receive a number of points for the sub-component 583 related to money the user has set aside for recreation based on a percentage a. The percentage a may be calculated based on the formula:

a=v÷(i×z),

where v is the amount of money the user has saved for recreation, i is the user's net income, and z is an ideal income percentage that should be set aside for recreation. In the current example, the user's net income i is $45,000. z may be given as a control parameter. In the current example, z=4%. Therefore:

a=$1,000÷($45,000×4%)=55.6%.

As shown in the table 514, the maximum number of possible points for the sub-component 583 related to the amount of money the user has saved for recreation is 5. Because 55.6% of 5 is 2.8, the user receives 2.8 points.

According to an embodiment of the invention, a user's score may be expressed as the percentage that the total number of points determined for the user comprises of the total maximum possible number of points. In the example illustrated in the tables 501-514 of FIGS. 5A-5E, as shown in sub-totals 515, 516, 517, 518, 519, 520, 535, 536, 537, 538, 539, 540, 584, and 585, the user's point totals are: 2.8+2.0+6.0+11.2+1.0+3.0+1.4+3.5+6.4+4.0+7.6+3.0+7.3+2.8=62. As shown in sub-totals 586, 587, 588, 589, 590, 591, 592, 593, 594, 595, 596, 597, 598, and 599, the total maximum number of possible points is: 3+2+17+40+2.5+3+5+15+15+5+9+3+16+5=140.5. Thus, the user's score may be expressed as 62+140.5=44%. In an embodiment, the user's score may be expressed as a number that is not a percentage.

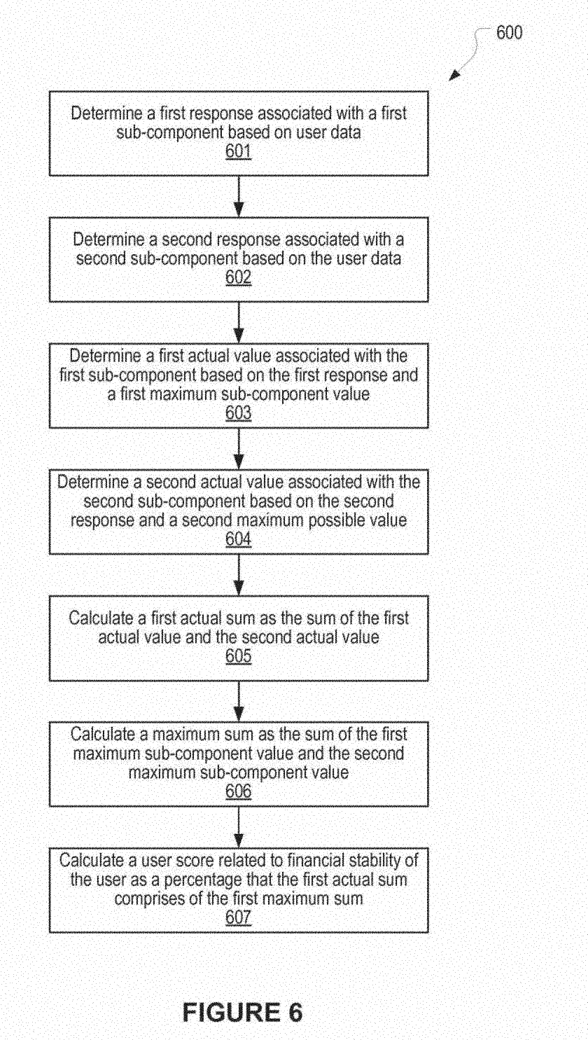

FIG. 6 illustrates a process 600 for determining a score based on a user's financial information in accordance with an embodiment of the invention. At block 601, the financial advice system 200 determines a first response associated with a first sub-component based on user data. At block 602, the financial advice system 200 determines a second response associated with a second sub-component based on the user data. The user data may include financial data such as, for example, account balances, transactions, or any other data related to the user's finances. The user data may include organization data such as, for example, information about the user's employment or his employer. The user data may include user-provided data such as, for example, the user's income, the user's marital status, how many children the user has, or any other data provided by the user. In an embodiment, the first sub-component and the second sub-component may be associated with the same score component. In an embodiment, the first sub-component and the second sub-component may be associated with different score components.

At block 603, the financial advice system 200 determines a first actual value associated with the first sub-component based on the first response and a first maximum sub-component value. At block 604, the financial advice system 200 determines a second actual value associated with the second sub-component based on the second response and a second maximum possible value. In an embodiment, the first maximum possible value and the second maximum possible value may be determined based on a first sub-component weight and a second sub-component weight, respectively. In an embodiment, the first maximum possible value and the second maximum possible value may be determined based further on a maximum score value. The maximum score value may be determined based on a score component weight.

At block 605, the financial advice system 200 calculates a first actual sum as the sum of the first actual value and the second actual value. At block 606, the financial advice system 200 calculates a maximum sum as the sum of the first maximum sub-component value and the second maximum sub-component value. At block 607, the financial advice system 200 calculates a user score related to financial stability of the user as a percentage that the first actual sum comprises of the first maximum sum. In an embodiment, the process 600 may be performed in whole or in part by any module within the financial advice system 200.

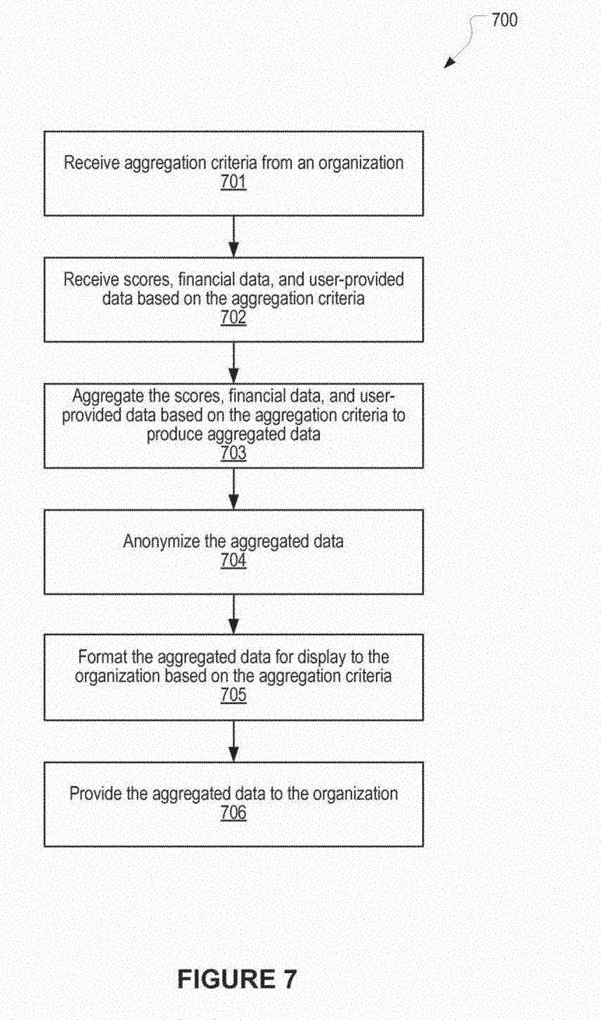

FIG. 7 illustrates a process 700 for aggregating score information to provide to an organization in accordance with an embodiment of the invention. At block 701, the financial advice system 200 receives aggregation criteria from the organization 102. In an embodiment, the organization 102 may be an employer. The aggregation criteria may comprise criteria for selecting user scores. The aggregation criteria may comprise visual criteria for presenting visual elements to the organization 102. At block 702, the financial advice system 200 receives scores, financial data, and user-provided data based on the aggregation criteria. At block 703, the financial advice system 200 aggregates the scores, financial data, and user-provided data based on the aggregation criteria to produce aggregated data. At block 704, the financial advice system 200 anonymizes the aggregated data. Anonymization may include the removal of names and other personal information from the aggregated data. At block 705, the financial advice system 200 formats the aggregated data for display to the organization 102 based on the aggregation criteria. At block 706, the financial advice system 200 provides the aggregated data to the organization 102. In an embodiment, the process 600 may be performed in whole or in part by any module within the financial advice system 200.

FIG. 8 is a diagrammatic representation of an embodiment of the machine 800, within which a set of instructions for causing the machine 800 to perform one or more of the embodiments described herein can be executed. The machine 800 may be connected (e.g., networked) to other machines. In a networked deployment, the machine 800 may operate in the capacity of a server or a client machine in a client-server network environment, or as a peer machine 800 in a peer-to-peer (or distributed) network environment. In one embodiment, the machine communicates with the server to facilitate operations of the server and/or to access the operations of the server.

The machine 800 includes a processor 802 (e.g., a central processing unit (CPU), a graphics processing unit (GPU), or both), a main memory 804, and a non-volatile memory 806 (e.g., volatile RAM and non-volatile RAM), which communicate with each other via a bus 808. In some embodiments, the machine 800 can be a desktop computer, a laptop computer, personal digital assistant (PDA), or mobile phone, for example. In one embodiment, the machine 800 also includes a video display 810, an alphanumeric input device 812 (e.g., a keyboard), a cursor control device 814 (e.g., a mouse), a drive unit 816, a signal generation device 818 (e.g., a speaker) and a network interface device 820.

In one embodiment, the video display 810 includes a touch sensitive screen for user input. In one embodiment, the touch sensitive screen is used instead of a keyboard and mouse. The disk drive unit 816 includes a machine-readable medium 822 on which is stored one or more sets of instructions 824 (e.g., software) embodying any one or more of the methodologies or functions described herein. The instructions 824 can also reside, completely or at least partially, within the main memory 804 and/or within the processor 802 during execution thereof by the machine 800. The instructions 824 can further be transmitted or received over a network 840 via the network interface device 820. In some embodiments, the machine-readable medium 822 also includes a database 825.

Volatile RAM may be implemented as dynamic RAM (DRAM), which requires power continually in order to refresh or maintain the data in the memory. Non-volatile memory 806 is typically a magnetic hard drive, a magnetic optical drive, an optical drive (e.g., a DVD RAM), or other type of memory system that maintains data even after power is removed from the system. The non-volatile memory 806 may also be a random access memory. The non-volatile memory 806 can be a local device coupled directly to the rest of the components in the data processing system. A non-volatile memory 806 that is remote from the system, such as a network storage device coupled to any of the computer systems described herein through a network interface such as a modem or Ethernet interface, can also be used.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine 800 and that cause the machine 800 to perform any one or more of the methodologies of the present disclosure. The term “machine-readable medium” shall accordingly be taken to include, but not be limited to, solid-state memories, optical and magnetic media, and carrier wave signals. The term “storage module” as used herein may be implemented using a machine-readable medium.

In general, the routines executed to implement the embodiments of the invention can be implemented as part of an operating system or a specific application, component, program, object, module or sequence of instructions referred to as “programs” or “applications”. For example, one or more programs or applications can be used to execute specific processes described herein. The programs or applications typically comprise one or more instructions set at various times in various memory and storage devices in the machine 800 and that, when read and executed by one or more processors, cause the machine 800 to perform operations to execute elements involving the various aspects of the embodiments described herein.

The executable routines and data may be stored in various places, including, for example, ROM, volatile RAM, non-volatile memory 806, and/or cache. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of machines, those skilled in the art will appreciate that the various embodiments are capable of being distributed as a program product in a variety of forms, and that the embodiments described herein apply equally regardless of the particular type of machine- or computer-readable media used to actually effect the distribution. Examples of machine-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, or the like means that a particular feature, design, structure, or characteristic described in connection with the embodiment is included in at least one embodiment of the disclosure. The appearances of, for example, the phrases “according to an embodiment”, “in one embodiment”, “in an embodiment”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described that may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

What is claimed:

1. A computer implemented method comprising:
associating, by a computer system, a first maximum sub-component value and a first actual value, based on first data related to financial conditions of a first user, with a first sub-component;
associating, by the computer system, a second maximum sub-component value and a second actual value, based on second data related to the financial conditions of the first user, with a second sub-component; and
determining, by the computer system, a first user score associated with financial stability of the first user based on the first maximum sub-component value and the first actual value associated with the first sub-component and the second maximum sub-component value and the second actual value associated with the second sub-component.

2. The computer implemented method of claim 1, further comprising:
associating the first maximum sub-component value and a third actual value, based on third data related to financial conditions of a second user, with the first sub-component;
associating the second maximum sub-component value and a fourth actual value, based on fourth data related to financial conditions of the second user, with the second sub-component; and
determining a second user score associated with financial stability of the second user based on the first maximum sub-component value and the third actual value associated with the first sub-component and the second maximum sub-component value and the fourth actual value associated with the second sub-component.

3. The computer implemented method of claim 1, further comprising:
determining the first maximum score component value based on a first sub-component weight; and
determining the second maximum score component value based on a second sub-component weight.

4. The computer implemented method of claim 1, further comprising:
selecting a first sub-component weight to adjust a contribution of the first sub-component on the first user score; and
selecting a second sub-component weight to adjust a contribution of the second sub-component on the first user score.

5. The computer implemented method of claim 1, wherein a score component includes the first sub-component and the second sub-component.

6. The computer implemented method of claim 5, wherein the score component relates to at least one of categorization of expenses, spending habits, emergency savings, retirement savings, medical savings, automated transfers, home equity, credit card debt, other debts, goals, budgeting, credit awareness, insurance, and recreation.

7. The computer implemented method of claim 5, further comprising associating a maximum score component value with the score component based on a score component weight.

8. The computer implemented method of claim 7, further comprising:
determining the first maximum sub-component value based on the maximum score component value and a first sub-component weight; and
determining the second maximum sub-component value based on the maximum score component value and a second sub-component weight.

9. The computer implemented method of claim 1, wherein a first score component includes the first sub-component and a second score component includes the second sub-component.

10. The computer implemented method of claim 1, further comprising determining the first actual value based on at least one of a target and a penalty threshold.

11. The computer implemented method of claim 10, further comprising determining the target based on a control parameter.

12. The computer implemented method of claim 10, further comprising determining the penalty threshold based on a control parameter.

13. The computer implemented method of claim 1, further comprising determining the first actual value based on a percentage of the first maximum sub-component value.

14. The computer implemented method of claim 1, further comprising
determining an actual sum based on a sum of the first actual value and the second actual value; and
determining a maximum sum based on a sum of the first maximum sub-component value and the second maximum sub-component value.

15. The computer implemented method of claim 14, wherein the first user score is based on a percentage determined as a quotient of the actual sum and the maximum sum.

16. The computer implemented method of claim 1, wherein the first data comprises at least one of financial data received from a financial data provider, organization data received from an organization, and data received from the first user.

17. The computer implemented method of claim 1, wherein the first sub-component relates to at least one of categorization of expenses, spending habits, emergency savings, retirement savings, medical savings, automated transfers, home equity, credit card debt, other debts, goals, budgeting, credit awareness, insurance, and recreation.

18. The computer implemented method of claim 1, further comprising:
generating aggregated data based on the first user score and a second user score;
anonymizing the aggregated data; and
providing the aggregated data to an organization.

19. A computer storage medium storing computer executable instructions that, when executed, cause a computer system to perform a computer implemented method comprising:
associating a first maximum sub-component value and a first actual value, based on first data related to financial conditions of a first user, with a first sub-component;
associating a second maximum sub-component value and a second actual value, based on second data related to the financial conditions of the first user, with a second sub-component; and
determining a first user score associated with financial stability of the first user based on the first maximum sub-component value and the first actual value associated with the first sub-component and the second maximum sub-component value and the second actual value associated with the second sub-component.

20. A system comprising:
at least one processor;
a memory storing instructions configured to instruct the at least one processor to perform:
associating a first maximum sub-component value and a first actual value, based on first data related to financial conditions of a first user, with a first sub-component;
associating a second maximum sub-component value and a second actual value, based on second data related to the financial conditions of the first user, with a second sub-component; and
determining a first user score associated with financial stability of the first user based on the first maximum sub-component value and the first actual value associated with the first sub-component and the second maximum sub-component value and the second actual value associated with the second sub-component.
